(19) United States
(12) Patent Application Publication
(10) Pub. No.: US 2014/0029697 A1
(43) Pub. Date: Jan. 30, 2014

(54) GMSK-Based Modulation in a Wireless Local Area Network

(71) Applicant: QUALCOMM Incorporated, San Diego, CA (US)

(72) Inventors: Lin Yang, San Diego, CA (US); Sameer Vermani, San Diego, CA (US); Didier Johannes Richard Van Nee, De Meern (NL); Hemanth Sampath, San Diego, CA (US); Vinent Knowles Jones, IV, Redwood City, CA (US)

(21) Appl. No.: 13/924,253

(22) Filed: Jun. 21, 2013

Related U.S. Application Data
(60) Provisional application No. 61/675,284, filed on Jul. 24, 2012.

(51) Int. Cl. H04L 27/20

(52) U.S. Cl. CPC H04L 27/2014
USPC 375/305; 375/336

(57) ABSTRACT

A method includes modulating, at a first wireless device, a first signal based on a Gaussian minimum shift keying (GMSK) modulation scheme to generate a modulated signal. The method also includes amplifying, at the first wireless device, the modulated signal using a nonlinear power amplifier to generate an output signal. The method further includes transmitting, from the first wireless device to a second wireless device, an output signal generated based on the modulated signal via a wireless local area network (WLAN) that is compliant with an Institute of Electrical and Electronics Engineer (IEEE) 802.11ah specification.

### CROSS-REFERENCE TO RELATED APPLICATIONS

The present application claims priority from commonly owned U.S. Provisional Patent Application No. 61/675,284, filed Jul. 24, 2012, entitled “GMSK-BASED MODULATION IN A WIRELESS LOCAL AREA NETWORK,” the contents of which are expressly incorporated herein by reference in their entirety.

### FIELD

The present disclosure relates to wireless networks and wireless devices.

### BACKGROUND

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet Protocol (IP) telephones, can communicate voice and data packets over wireless networks. Many such wireless telephones incorporate additional devices to provide enhanced functionality for end users. For example, a wireless telephone can also include a digital still camera, a digital video camera, a digital recorder, and an audio file player. Also, such wireless telephones can execute software applications, such as a web browser application that can be used to access the Internet. As such, these wireless telephones can include significant computing capabilities.

A wireless device may communicate with another wireless device via a wireless local area network (WLAN). The WLAN may be compliant with one or more industry standards. For example, the WLAN may be compliant with an Institute of Electrical and Electronics Engineers (IEEE) 802.11ah standard. Signals to be transmitted via the IEEE 802.11ah network are modulated based on an orthogonal frequency-division multiplexing (OFDM) modulation scheme. OFDM modulation is a “mandatory mode” of current IEEE 802.11ah devices. A linear power amplifier is used to implement the OFDM modulation scheme in a transmitter or a receiver. A linear power amplifier operates throughout an entire cycle of an input signal waveform, resulting in low power conversion efficiency. Accordingly, a transmitter or a receiver with a linear power amplifier may have low power efficiency (e.g., 25% power efficiency). A device transmitting an OFDM modulated signal via an IEEE 802.11ah compliant WLAN may have a poor signal range due to the low power conversion efficiency of the linear power amplifier. A larger linear power amplifier may be used to compensate for the low power conversion efficiency. However, a larger linear power amplifier dissipates more heat as compared to a smaller linear power amplifier. Thus, additional or larger heat sinks are needed when a large linear amplifier is used.

### SUMMARY

Modulating a signal to be transmitted via a WLAN (e.g., an IEEE 802.11ah WLAN) using OFDM may reduce power efficiency of a transmitter or a receiver. The systems and methods described herein may advantageously enable a device to modulate signal to be transmitted via an IEEE 802.11ah WLAN using Gaussian minimum shift keying (GMSK) instead of OFDM. GMSK modulation may provide improved power efficiency when compared to OFDM modulation because GMSK modulation may enable the use of a non-linear power amplifier. Thus GMSK modulation may provide enhanced performance as compared to OFDM modulation in certain scenarios, such as single carrier transmission via an IEEE 802.11ah WLAN.

For example, a transmitter of a first device may apply a GMSK modulation scheme to modulate an input signal to be transmitted via a WLAN (e.g., an IEEE 802.11ah WLAN). In a particular embodiment, the input signal corresponds to one or more packets. The transmitter may encode the input signal using binary convolutional codes (BCC) encoding before applying the GMSK modulation scheme. The transmitter may amplify the input signal using a nonlinear power amplifier to generate an output signal and may transmit the output signal to a second device. The second device may receive the output signal via the WLAN. The second device may apply GMSK demodulation and BCC decoding to the received signal to recover the input signal.

In a particular embodiment, a method includes modulating, at a first wireless device, a first signal based on a Gaussian minimum shift keying (GMSK) modulation scheme to generate a modulated signal. The method also includes amplifying, at the first wireless device, the modulated signal using a nonlinear power amplifier to generate an output signal. The method further includes transmitting, from the first wireless device to a second wireless device, the output signal via a wireless local area network (WLAN) that is compliant with an Institute of Electrical and Electronics Engineer (IEEE) 802.11ah specification. The method may further include encoding a second input signal using a binary convolutional codes (BCC) encoder to generate a second input signal. The method may further include modulating a second signal based on an orthogonal frequency-division multiplexing (OFDM) modulation scheme to generate a second modulated signal. The method may further include amplifying the second modulated signal using a linear power amplifier to generate a second output signal. The method may further include transmitting, from the first wireless device to a third wireless device, the second output signal via the WLAN.

In another particular embodiment, a method includes receiving, at a wireless device, a signal via a wireless local area network (WLAN) that is compliant with an Institute of Electrical and Electronics Engineer (IEEE) 802.11ah specification. The method also includes demodulating, at the wireless device, the received signal using a GMSK demodulator to generate a first signal and decoding, at the wireless device, the first signal using a binary convolutional codes (BCC) decoder to generate an output signal when the received signal is modulated based on a Gaussian minimum shift keying (GMSK) modulation scheme. The output signal corresponds to one or more packets. The method further includes demodulating, at the wireless device, the received signal using an OFDM demodulator to generate the first signal and decoding, at the wireless device, the first signal using the BCC decoder to generate the output signal when the received signal is modulated based on a orthogonal frequency-division multiplexing (OFDM) modulation scheme.

In another particular embodiment, a method includes generating, at a wireless device, a Gaussian minimum shift keying (GMSK) modulated packet to be transmitted through a wireless local area network (WLAN) that is compliant with an Institute of Electrical and Electronics Engineer (IEEE) 802.11ah specification. The packet includes a preamble. The preamble includes a synchronization (SYNC) field and a start frame delimiter (SFD) field. The packet also includes a header portion. The header portion includes a length field and a cyclic redundancy check (CRC) field. The packet further includes a payload portion.

In another particular embodiment, an apparatus includes a modulator configured to modulate a first signal based on a Gaussian minimum shift keying (GMSK) modulation scheme to generate a modulated signal. The apparatus also includes a nonlinear power amplifier configured to amplify the modulated signal to generate an output signal. The apparatus further includes a transmitter configured to transmit the output signal generated based on the amplified signal via a wireless local area network (WLAN) that is compliant with an Institute of Electrical and Electronics Engineer (IEEE) 802.11ah specification.

In another particular embodiment, an apparatus includes a receiver configured to receive a signal via a wireless local area network (WLAN) that is compliant with an Institute of Electrical and Electronics Engineer (IEEE) 802.11ah specification. The apparatus also includes a Gaussian minimum shift keying (GMSK) demodulator configured to demodulate the received signal based on a GMSK demodulation scheme to generate a first signal when the received signal is modulated based on a GMSK modulation scheme. The apparatus further includes an orthogonal frequency-division multiplexing (OFDM) demodulator configured to demodulate the received signal based on a OFDM demodulation scheme to generate the first signal when the received signal is modulated based on an OFDM modulation scheme. The apparatus further includes a binary convolutional codes (BCC) decoder configured to decode the first signal to generate an output signal. The output signal corresponds to one or more packets.

One particular advantage provided by at least one of the disclosed embodiments is an ability of a device to transmit and receive GMSK-modulated signals via a WLAN (e.g., an IEEE 802.11ah WLAN), which may provide improved power efficiency (e.g., mobile device battery life) as compared to using OFDM modulation. Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a diagram to illustrate a particular embodiment of a system operable to enable communication of a Gaussian minimum shift keying modulated signal via a WLAN;

FIG. 2 is a block diagram to illustrate a Gaussian minimum shift keying modulator operable to modulate a signal using a Gaussian minimum shift keying modulation scheme;

FIG. 3 is a diagram to illustrate a particular embodiment of a packet format corresponding to a packet derived from the Gaussian minimum shift keying modulated signal of FIG. 1;

FIG. 4 is a diagram to illustrate a particular embodiment of a power spectrum density graph of the Gaussian minimum shift keying modulated signal of FIG. 1;

FIG. 5 is flowchart to illustrate a particular embodiment of a method of operation at a transmitting device of FIG. 1;

FIG. 6 is flowchart to illustrate a particular embodiment of a method of operation at a receiving device of FIG. 1; and

FIG. 7 is a block diagram of a communication device including components that are operable to process the Gaussian minimum shift keying modulated signal of FIG. 1.

### DETAILED DESCRIPTION

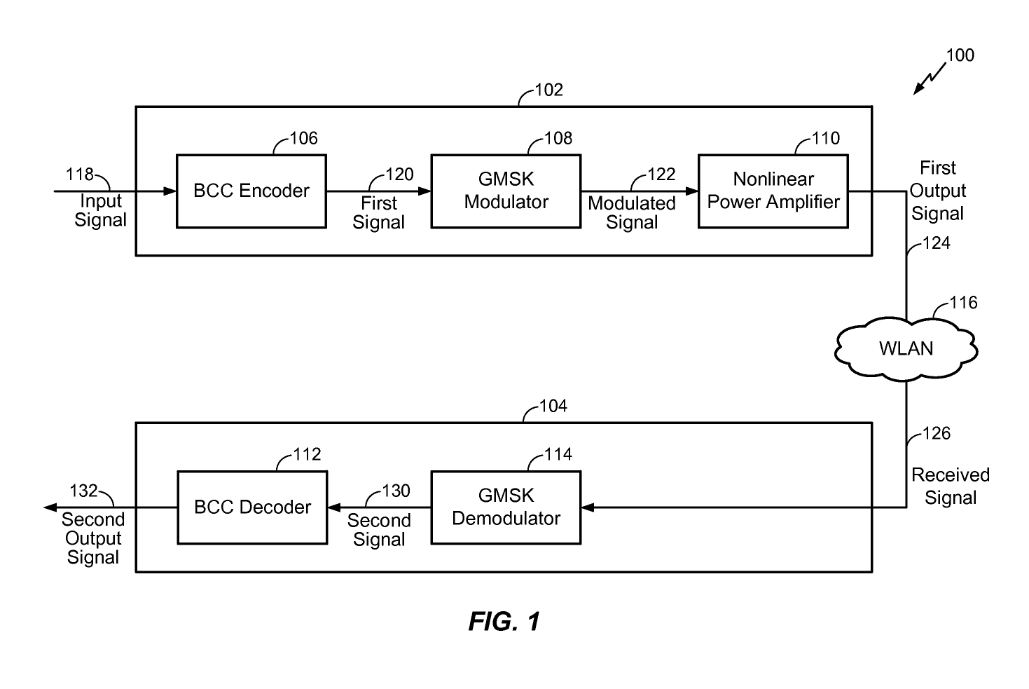

FIG. 1 is a diagram to illustrate a particular embodiment of a system 100 operable to enable communication of a Gaussian minimum shift keying (GMSK) modulated signal via a wireless local area network (WLAN). The system 100 includes a first wireless device 102 (e.g., a mobile communication device, a tablet computer, a laptop computer, a desktop computer, an audio player, other electronic device, or combinations thereof) and a second wireless device 104 (e.g., a mobile communication device, a tablet computer, a laptop computer, a desktop computer, an audio player, other electronic device, or combinations thereof). The first wireless device 102 may communicate with the second wireless device 104 via a WLAN 116. In a particular embodiment, the WLAN 116 is an Institute of Electrical and Electronics Engineers (IEEE) 802.11ah network.

IEEE 802.11ah networks may be used for sensors, metering, and smart grid networks. Devices implementing the IEEE 802.11ah standard may consume less power than devices implementing other wireless protocols, and/or may be used to transmit wireless signals across a relatively long range, for example about one kilometer or longer. Devices implementing the IEEE 802.11ah standard, whether used as a mobile station, an access point, or other device, may be used for smart metering or in a smart grid network. Such devices may provide sensor applications or may be used in home automation. The devices may instead, or in addition, be used in a healthcare context, such as personal healthcare. As other examples, the devices may also be used for surveillance, to enable extended-range Internet connectivity (e.g., for use with hotspots), or to implement machine-to-machine communications.

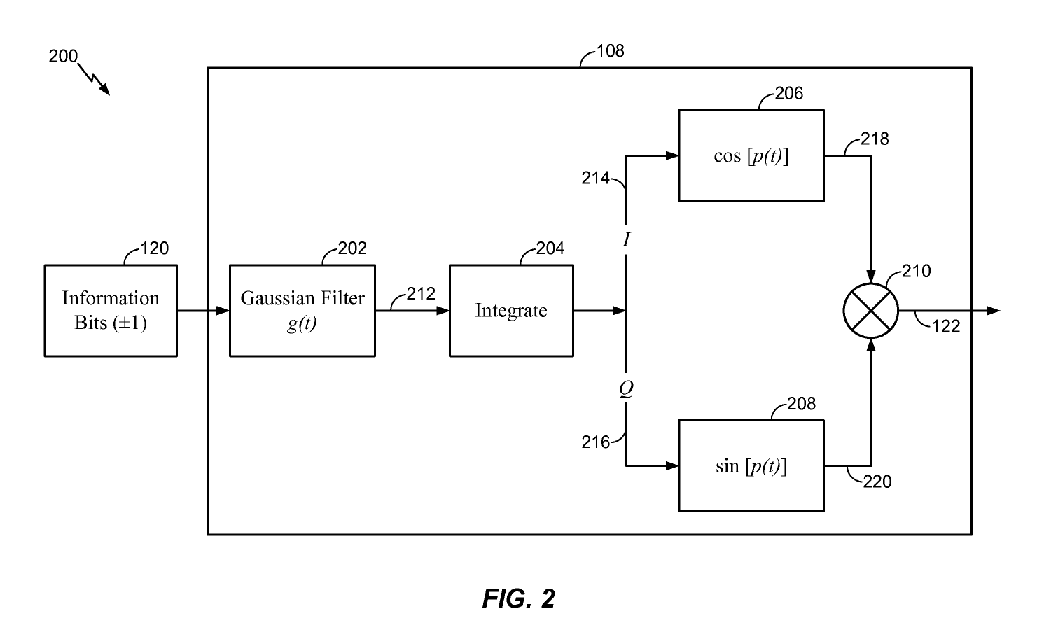

The first wireless device 102 may include a binary convolutional codes (BCC) encoder 106, a GMSK modulator 108, and a nonlinear power amplifier 110. The BCC encoder 106 may be coupled to the GMSK modulator 108. The GMSK modulator 108 may be coupled to the nonlinear power amplifier 110. A particular embodiment of the GMSK modulator 108 is further described with reference to FIG. 2. The second wireless device 104 may include a BCC decoder 112 and a GMSK demodulator 114 The BCC decoder 112 may be coupled to the GMSK demodulator 114. For ease of explanation, the first wireless device 102 is shown in FIG. 1 as including transmit-side components and the second wireless device 104 is shown as including receive-side components. In another particular embodiment, the wireless devices 102, 104 may each include transmit-side and receive-side components, thereby enabling two-way communication of GMSK modulated signals, as further described herein.

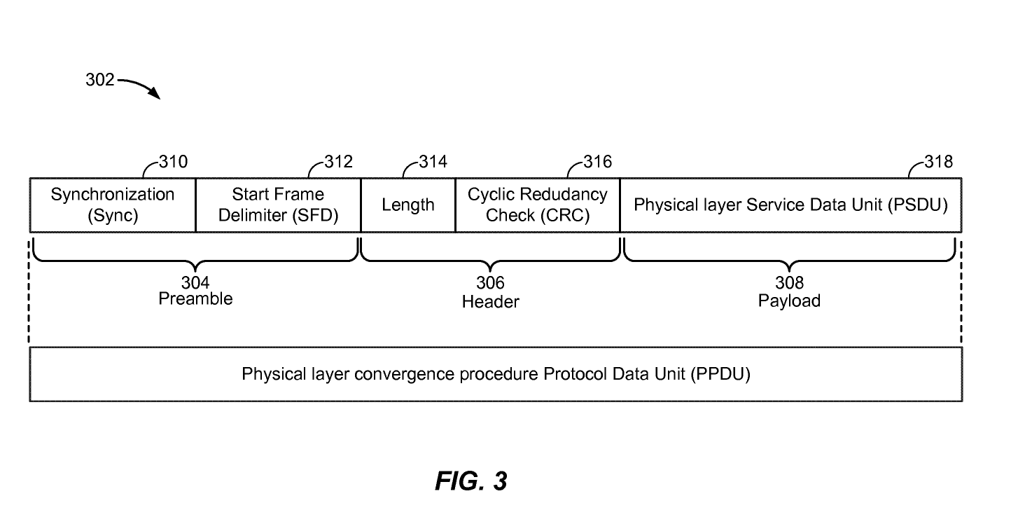

During operation, the first wireless device 102 may receive an input signal 118 from a first input source (e.g., a signal generated by a user or an application executing at the first wireless device 102). In a particular embodiment, the input signal 118 corresponds to one or more packets. A particular embodiment of a packet format is further described with reference to FIG. 3. The input signal 118 may be received at the BCC encoder 106 for encoding. In a particular embodiment, the input signal 118 is encoded as a sequence of bits. The BCC encoder 106 may encode the input signal using BCC encoding to generate a first signal 120. The BCC encoder 106 may transmit the first signal 120 to the GMSK modulator 108 for modulation. Application of an interleaver before the first signal 120 is modulated may be avoided because every bit of the input signal 118 may exploit the same amount of delay diversity. The GMSK modulator 108 may modulate the first signal 120 based on a GMSK modulation scheme to generate a modulated signal 122. In a particular embodiment, the GMSK modulation scheme has a modulation index of 0.5. In another particular embodiment, the GMSK modulation scheme is a mandatory modulation scheme (i.e., mandatory mode) of the WLAN 116 (e.g., as defined by an industry standard, such as IEEE 802.11ah). The modulated signal 122 may be transmitted to the nonlinear power amplifier 110 by the GMSK modulator 108 for power amplification. The nonlinear power amplifier 110 may nonlinearly amplify the modulated signal 122 to generate a first output signal 124. The first wireless device 102 may transmit the first output signal 124 to the second wireless device 104 via the WLAN 116. In a particular embodiment, the first wireless device 102 transmits the first output signal 124 using a single carrier of the WLAN 116. In a particular embodiment, a GMSK modulated ready to send (RTS) message and a GMSK modulated clear to send (CTS) message are used to prepare (e.g., reserve) the single carrier of the WLAN 116 prior to transmission of the first output signal 124. Although not shown, it should be noted that other signal processing components may also be used in generating the first output signal 124. For example, a digital-to-analog converter may be used prior to modulation and/or power amplification.

The second wireless device 104 may receive the first output signal 124 as a received signal 126. The GMSK demodulator 114 may receive the received signal 126 (e.g., for demodulation). The GMSK demodulator 114 may demodulate the amplified received signal 128 based on a GMSK demodulation scheme (i.e., an inverse of the GMSK modulation scheme of the GMSK modulator 108) to generate a second signal 130. In a particular embodiment, coherent demodulation is used at the GMSK demodulator 114. The BCC decoder 112 may receive the second signal 130 from the GMSK demodulator 114 and may decode the second signal 130 using BCC decoding (e.g., an inverse of the BCC encoding performed by the BCC encoder 106) to generate a second output signal 132. In the absence of network and signal processing errors, the second output signal 132 corresponds to the one or more packets represented by the input signal 118. In a particular embodiment, linear equalization may be used to mitigate inter-symbol interference (ISI) introduced by Gaussian filtering, multipath, and/or filtering at the second wireless device 104.

The system 100 may thus enable a device (e.g., the first wireless device 102) to transmit a modulated signal (e.g., the first output signal 124) to another device (e.g., the second wireless device 104) via a wireless local area network (e.g., the WLAN 116) without using OFDM. Communication of signals without using OFDM may improve power efficiency of the devices because a relatively strict (e.g., class A) linear power amplifier required for OFDM may be replaced with a nonlinear power amplifier (e.g., a class C-E amplifier). Improved power efficiency may result in range extension and/or improved bit error rate (BER) performance when compared to OFDM.

FIG. 2 is a block diagram to illustrate a particular embodiment of the GMSK modulator 108 of FIG. 1 and is generally designated 200. The GMSK modulator 108 may include a Gaussian filter 202, an integration stage 204, a cosine carrier 206 (e.g., a cosine function), a sine carrier 208 (e.g., a sine function), and an adder 210.

In a particular embodiment, the first signal 120 is received at the GMSK modulator 108 as a sequence of differentially encoded bits (e.g., a differentially encoded sequence of 1s and/or 0s). The Gaussian filter 202 is applied to the first signal 120 to generate a filtered signal 212. In a particular embodiment, the Gaussian filter 202 has a bandwidth time product (BT) value of 0.3. The filtered signal 212 may be integrated at the integration stage 204 to generate an in-phase (I) component 214 and a quadrature (Q) component 216. In another embodiment, the first signal 120 is integrated at the integration stage 204 to generate the I component 214 and the Q component 216 before applying the Gaussian filter 202 to the I component 214 and to the Q component 216. The I component 214 may be multiplied by the cosine carrier 206 to generate a first multiplied signal 218. The Q component 216 may be multiplied by the sine carrier 208 to generate a second multiplied signal 220. The first multiplied signal 218 and the second multiplied signal 220 may be added at the adder 210 to generate the modulated signal 122.

FIG. 3 is a diagram to illustrate a particular embodiment of a packet format corresponding to a packet 302 that may be processed in accordance with the GMSK modulation techniques described herein. The packet 302 may include a preamble 304, a header portion 306, and a payload portion 308 (e.g., a media access control (MAC) protocol data unit (MPDU)). The preamble 304 may include a synchronization (SYNC) field 310 and a start frame delimiter (SFD) field 312. The preamble 304 may be used for synchronization and parameter estimation. In a particular embodiment, the preamble 304 may be used for estimation of parameters such as an automatic gain control (AGC) setting, direct current (DC) estimation, frequency and channel estimation, noise estimation, or a combination thereof. The SYNC field 310 and the SFD field 312 may each include a number of bits. In a particular embodiment, the SYNC field 310 has 56 bits of scrambled zero bits. In a particular embodiment, the SFD field 312 is 8 bits. In another particular embodiment, the SFD field is 16 bits.

The header portion 306 may include a length field 314 and a cyclic redundancy check (CRC) field 316. The length field 314 and the cyclic redundancy check (CRC) field 316 may each include a number of bits. The length field 314 may be used for deferral and reception. In a particular embodiment, the length field is 8 bits. In another particular embodiment, the length field is 9 bits. The CRC field 316 may be used for integrity protection. In a particular embodiment, the CRC field 316 is 4 bits. In a particular embodiment, the header portion 306 includes only the length field 314 and the CRC field 316. Thus, the header portion 306 may be shorter than the header portion of packets modulated using non-GMSK schemes (e.g., OFDM), because such (non-GMSK) packets may include additional fields, such as short training fields (STFs) and long training fields (LTFs). The payload portion 308 may include protocol data units (PDUs). In a particular embodiment, the payload portion 308 includes MPDUs, physical layer service PDUs (PSDUs), or any combination thereof

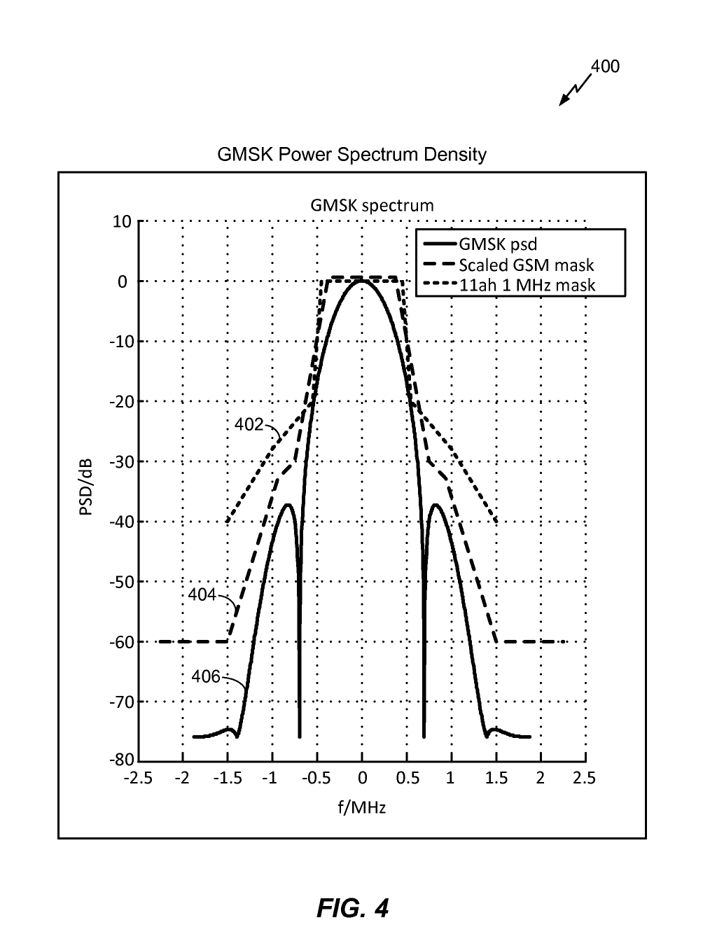

FIG. 4 is a diagram to illustrate a particular embodiment of a power spectrum density graph of the first output signal 124 in FIG. 1 and is generally designated 400. A first waveform 402 may represent a 1 MHz mask of an OFDM modulated signal to be transmitted in an IEEE 802.11ah network. The first waveform 402 may have a peak at zero decibels (dB). A second waveform 404 may represent a scaled mask for a global system for mobile communications (GSM) signal modulated using GMSK. The second waveform 404 may also have a peak at zero dB.

A third waveform 406 may represent a power spectrum density of a GMSK modulated signal to be transmitted in the IEEE 802.11ah network (e.g., the first output signal 124 of FIG. 1). In a particular embodiment, the third waveform 406 may be generated using an empirical model with a BT value of 0.3 and a GMSK radio frequency bandwidth of 0.75 MHz (i.e., scaled up by a factor of 3.75 when compared to a GMSK modulated GSM signal). It will be noted that the third waveform 406 may have also a peak at zero dB, indicating that GMSK modulation may provide comparable signal strength to OFDM modulation in IEEE 802.11ah networks.

In a particular embodiment, the third waveform 406 corresponds to a bit rate of 1.0156 Mbps (scaled up by a factor of 3.75 when compared to a GMSK modulated GSM signal without considering pilot overhead or coding). This bit-rate may be higher than the bit-rate provided by OFDM modulation in IEEE 802.11ah networks. As illustrated in FIG. 4, the third waveform 406 closely adheres to the first waveform 402 and the second waveform 404 as all three have a peak at zero dB that occurs approximately between −0.5 MHz and 0.5 MHz. Thus, use of GMSK modulation for IEEE 802.11ah networks may result in acceptable spectral mask characteristics (e.g., reduced interference in neighboring channels). In accordance with the described embodiments, GMSK modulation may be added as another mandatory mode to the IEEE 802.11ah wireless standard and/or may replace OFDM as the mandatory mode of the IEEE 802.11ah wireless standard.

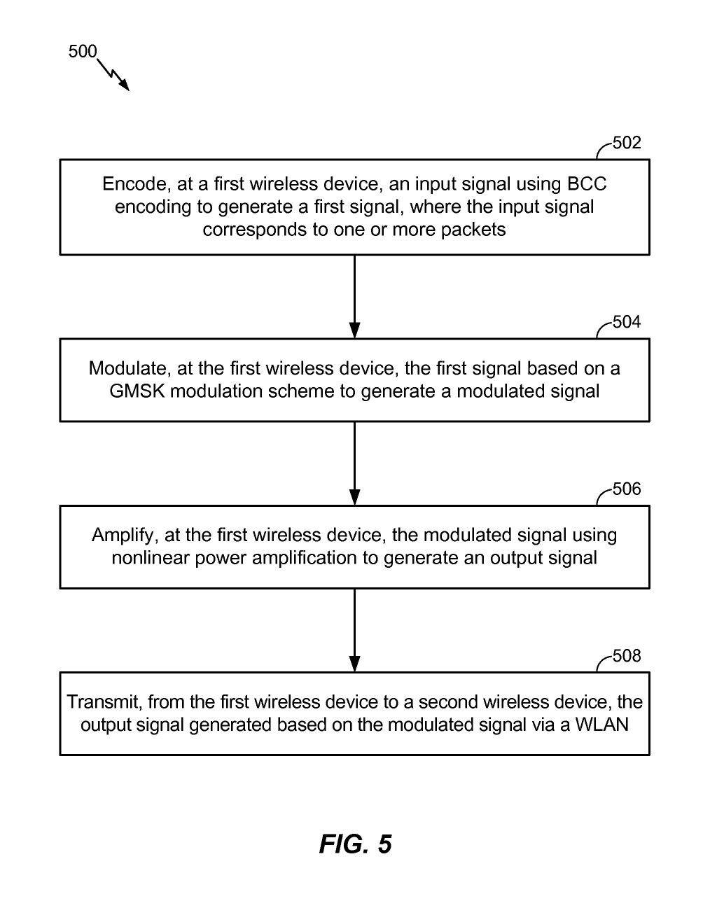

FIG. 5 is flowchart to illustrate a particular embodiment of a method of operation at a transmitting device (e.g., the first wireless device 102 of FIG. 1) and is generally designated 500. The method 500 may include encoding, at a first wireless device, an input signal using BCC encoding to generate the first signal, at 502. The input signal may correspond to one or more packets. For example, in FIG. 1, the BCC encoder 106 may encode the input signal 118 to generate the first signal 120. The method 500 also includes modulating, at the first wireless device, the first signal based on a GMSK modulation scheme to generate a modulated signal, at 504. For example, in FIG. 1, the GMSK modulator 108 may modulate the first signal 120 to generate the modulated signal 122.

The method 500 may further include amplifying, at the first wireless device, the modulated signal using nonlinear power amplification to generate an output signal, at 506. For example, the nonlinear power amplifier 110 may amplify the modulated signal 122 to generate the first output signal 124. The method 500 further includes transmitting, from the first wireless device to a second wireless device, the output signal generated based on the modulated signal via a WLAN, at 508. For example, in FIG. 1, the first wireless device 102 may transmit the first output signal 124 to the second wireless device 104 via the WLAN 116.

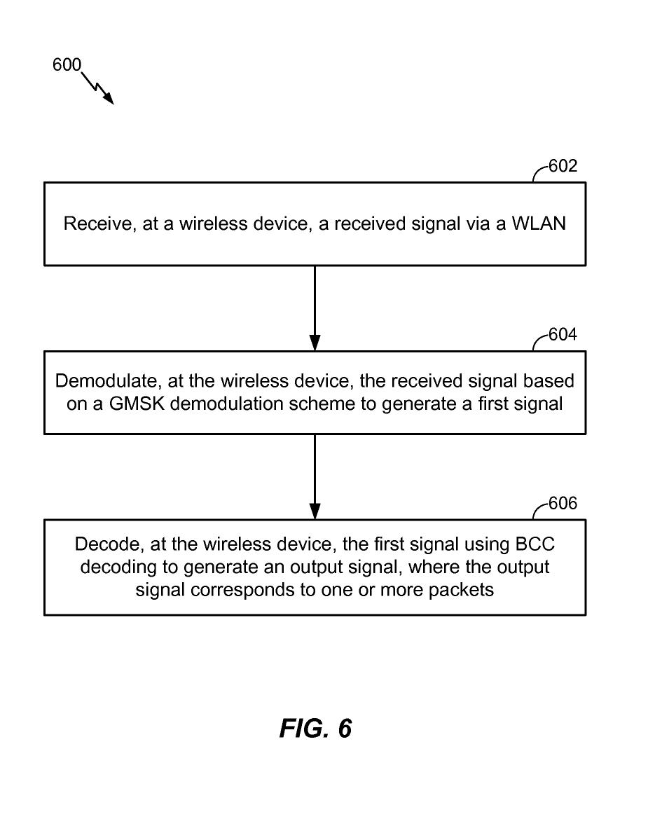

FIG. 6 is flowchart to illustrate a particular embodiment of a method of operation at a receiving device (e.g., the second wireless device 104 of FIG. 1) and is generally designated 600. The method 600 may include receiving, at a wireless device, a received signal via a WLAN, at 602. For example, in FIG. 1, the second wireless device 104 may receive the first output signal 124 as the received signal 126 via the WLAN 116. The method 600 may also include demodulating, at the wireless device, the received signal based on a GMSK demodulation scheme to generate a first signal, at 604. For example, in FIG. 1, the GMSK demodulator 114 may demodulate the amplified received signal 128 to generate the second signal 130.

The method 600 may further include decoding, at the wireless device, the first signal using BCC decoding to generate an output signal, at 606. The output signal may correspond to one or more packets. For example, in FIG. 1, the BCC decoder 112 may decode the second signal 130 to generate the second output signal 132.

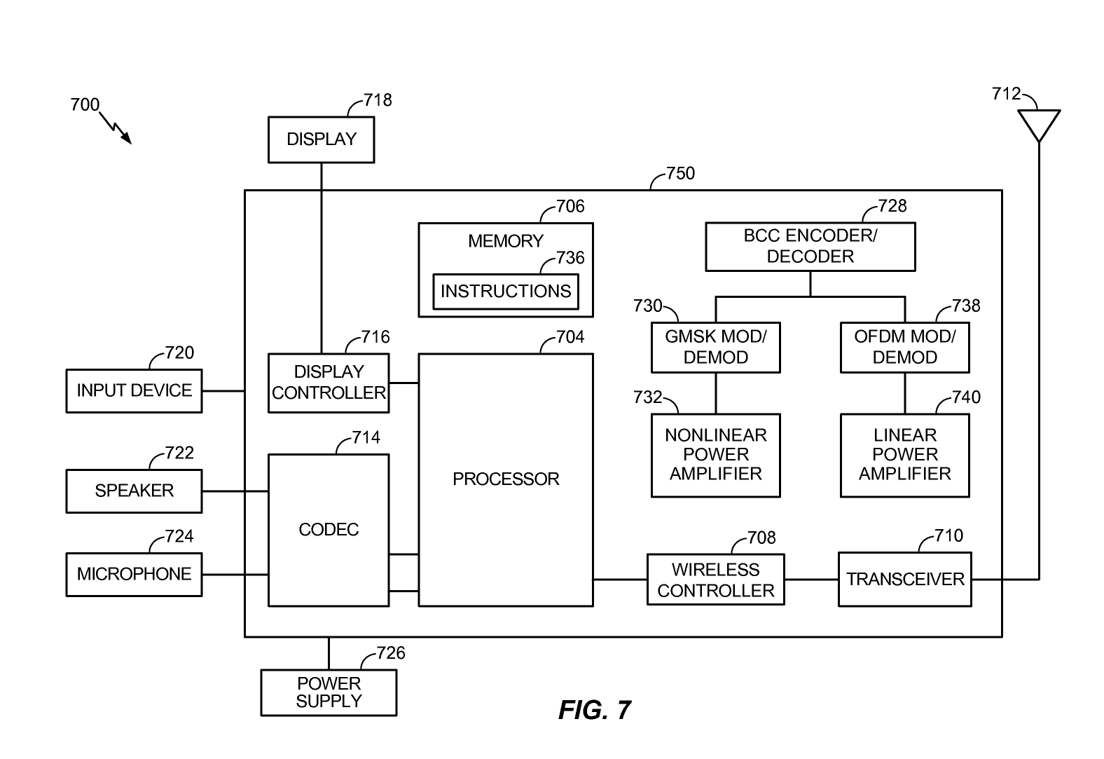

FIG. 7 is a block diagram of a communication device 700 including components that are operable to process a GMSK modulated signal. In an illustrative embodiment, the GMSK modulated signal may be the first output signal 124. In an illustrative embodiment, the communication device 700 may be the first wireless device 102. In another illustrative embodiment, the communication device 700 may be the second wireless device 104. In another illustrative embodiment, the communication device 700, or components thereof, include or are included within the first wireless device 102 of FIG. 1, the second wireless device 104 of FIG. 1, or a combination thereof. Further, all or part of the methods described in FIGS. 5 and 6 may be performed at or by the communication device 700. The communication device 700 may include a processor 704 (e.g., a digital signal processor) coupled to a memory 706.

The memory 706 may be a non-transitory tangible computer-readable and/or processor-readable storage device that stores instructions 736. The instructions 736 may be executable by the processor 704 to perform one or more functions or methods described herein, such as the methods described with reference to FIGS. 5 and 6. FIG. 7 shows that the communication device 700 may also include a display controller 716 that is coupled to the processor 704 and to a display 718. A coder/decoder (CODEC) 714 can also be coupled to the processor 704. A speaker 722 and a microphone 724 can be coupled to the CODEC 714. FIG. 7 also indicates that a wireless controller 708 may be coupled to the processor 704, where the wireless controller 708 is in communication with an antenna 712 via a transceiver 710. The wireless controller 708, the transceiver 710, and the antenna 712 may thus represent a wireless interface that enables wireless communication by the communication device 700. For example, in an embodiment where the communication device 700 is the first wireless device 102 of FIG. 1, such a wireless interface may be used to communicate with the second wireless device 104 of FIG. 1, as shown. The communication device 700 may include numerous wireless interfaces, where different wireless networks are configured to support different networking technologies or combinations of networking technologies. For example, the communication device 700 may include an IEEE 802.11ah wireless interface.

FIG. 7 also indicates that the communication device 700 may include a BCC encoder/decoder 728. The BCC encoder/decoder 728 may be coupled to a GMSK modulator/demodulator 730 and to an OFDM modulator/demodulator 738. The GMSK modulator/demodulator 730 may be configured to modulate a signal to be transmitted based on a GMSK modulation scheme and to demodulate a GMSK modulated received signal based on a GMSK demodulation scheme. The OFDM modulator/demodulator 738 may be configured to modulate a signal to be transmitted based on an OFDM modulation scheme and to demodulate an OFDM modulated received signal based on an OFDM demodulation scheme.

In a particular embodiment, the BCC encoder/decoder 728 is shared by the GMSK modulator/demodulator 730 and the OFDM modulator/demodulator 738. For example, to prepare a signal for transmission, the BCC encoder/decoder 728 may encode the signal before sending the encoded signal to the GMSK modulator/demodulator 730 or to the OFDM modulator/demodulator 738, depending on the modulation scheme to be used. To process a received signal, the BCC encoder/decoder 728 may decode a demodulated signal received from the GMSK modulator/demodulator 730 or the OFDM modulator/demodulator 738. In another particular embodiment, each of the GMSK modulator/demodulator 730 and the OFDM modulator/demodulator 738 is coupled to a separate BCC encoder/decoder.

In an illustrative embodiment, the BCC encoder/decoder 728 is operable to perform the functions described with reference to the BCC encoder 106 of FIG. 1 and the BCC decoder 112 of FIG. 1. In an illustrative embodiment, the GMSK modulator/demodulator is operable to perform the functions described with reference to the GMSK modulator 108 of FIGS. 1-2 and the GMSK demodulator 114 of FIG. 1.

The communication device 700 may include a nonlinear power amplifier 734 coupled to the GMSK modulator/demodulator 730. In an illustrative embodiment, the nonlinear power amplifier 734 is the nonlinear power amplifier 110 of FIG. 1 (e.g., a class C-E amplifier). The communication device 700 may also include a linear power amplifier 740 coupled to the OFDM modulator/demodulator 738. When a signal to be transmitted is modulated according to the GMSK modulation scheme, the nonlinear power amplifier 734 is configured to amplify the modulated signal before the amplified modulated signal is transmitted via the antenna 712. When a signal to be transmitted is modulated according to the OFDM modulation scheme, the linear power amplifier 740 is configured to amplify the modulated signal before the amplified modulated signal is transmitted via the antenna 712. In a particular embodiment, the communication device 700 includes the BCC encoder/decoder 728, the GMSK modulator/demodulator 730, and the nonlinear power amplifier 732 but does not include the OFDM modulator/demodulator 738 or the linear power amplifier 740.

The BCC encoder/decoder 728, the GMSK modulator/demodulator 730, the OFDM modulator/demodulator 738, the nonlinear power amplifier 734, and/or the linear power amplifier 740 may be implemented within, or as a part of, the processor 704, the wireless controller 708, and/or the transceiver 710. In a particular embodiment, the BCC encoder/decoder 728, the GMSK modulator/demodulator 730, and/or the nonlinear power amplifier 734 are implemented as hardware components of the communication device 700. In a particular embodiment, the BCC encoder/decoder 728, the GMSK modulator/demodulator 730, and/or the nonlinear power amplifier 734 are implemented as instructions executable by the processor 704 (e.g., the instructions 736).

In a particular embodiment, the processor 704, the display controller 716, the memory 706, the CODEC 714, the wireless controller 708, the transceiver 710, the BCC encoder/decoder 728, the GMSK modulator/demodulator 730, the OFDM modulator/demodulator 738, the nonlinear power amplifier 734, and the linear power amplifier 740 are included in a system-in-package or system-on-chip device 750. In a particular embodiment, an input device 720 and a power supply 726 are coupled to the system-on-chip device 750. Moreover, in a particular embodiment, as illustrated in FIG. 7, the display device 718, the input device 720, the speaker 722, the microphone 724, the antenna 712, and the power supply 726 are external to the system-on-chip device 750. However, each of the display device 718, the input device 720, the speaker 722, the microphone 724, the antenna 712, and the power supply 726 can be coupled to a component of the system-on-chip device 750, such as an interface or a controller.

One or more components of the communication device 700 or components analogous thereto, may be integrated into a wireless device, such as the first wireless device 102 of FIG. 1, the second wireless device 104 of FIG. 1, or any combination thereof. For example, the first wireless device 102 of FIG. 1 and the second wireless device 104 of FIG. 1 may include a wireless controller, a transceiver, an antenna, a processor, and a memory storing instructions executable by a processor to perform all or part of one or both of the methods of FIGS. 5 and 6.

In conjunction with the described embodiments, an apparatus may include means for modulating a first signal based on a GMSK modulation scheme to generate a modulated signal. For example, the means for modulating may include the GMSK modulator 108 of FIGS. 1-2, the GMSK modulator/demodulator 730 of FIG. 7, one or more other devices configured to modulate data, or any combination thereof. The apparatus may also include means for amplifying the modulated signal nonlinearly to generate an output signal. For example, the means for amplifying may include the nonlinear power amplifier 110 of FIG. 1, the nonlinear power amplifier 734 of FIG. 7, one or more devices configured to amplify the power of a signal, or any combination thereof. The apparatus may further include means for transmitting the output signal via a WLAN that is compliant with an IEEE 802.11ah specification. For example, the means for transmitting may include one or more components (e.g., a transmitter) of the first wireless device 102 of FIG. 1, the wireless controller 708, the transceiver 710, the antenna 712 of FIG. 7, one or more other devices configured to transmit data, or any combination thereof

The apparatus may further include means for encoding that is configured to encode an input signal based on a BCC encoding scheme to generate the first signal and to encode a second input signal to generate a second signal. For example, the means for encoding may include the BCC encoder 106 of FIG. 1, the BCC encoder/decoder 728 of FIG. 7, one or more other devices configured to encode data, or any combination thereof. The apparatus may further include second means for modulating a second signal based on an OFDM modulation scheme to generate a second modulated signal. For example, the second means for modulating may include the OFDM modulator/demodulator 738 of FIG. 7, one or more other devices configured to modulate data, or any combination thereof

Another apparatus may include means for receiving a signal via a WLAN. For example, the means for receiving may include one or more components (e.g., a receiver) of the second wireless device 104 of FIG. 1, the wireless controller 708, the transceiver 710, the antenna 712 of FIG. 7, one or more other devices configured to receive data, or any combination thereof. The apparatus may also include first means for demodulating the received signal. The first means for demodulating may be configured to demodulate the received signal based on a GMSK demodulation scheme to generate a first signal when the received signal is modulated based on a GMSK modulation scheme. For example, the first means for demodulating may include the GMSK demodulator 114 of FIG. 1, the GMSK modulator/demodulator 730 of FIG. 7, one or more other devices configured to demodulate data based on a GMSK demodulation scheme, or any combination thereof

The apparatus may further include second means for demodulating the receive signal. The second means for demodulating may be configured to demodulate the received signal based on an OFDM demodulation scheme to generate the first signal when the received signal is modulated based on an OFDM modulation scheme. For example, the second means for demodulating may include the OFDM modulator/demodulator 738 of FIG. 7, one or more other devices configured to demodulate data based on an OFDM demodulation scheme, or any combination thereof

The apparatus may further include means for decoding the first signal based on a BCC decoding scheme to generate an output signal. For example, the means for decoding may include the BCC decoder 112 of FIG. 1, the BCC encoder/decoder 728 of FIG. 7, one or more other devices configured to decode data, or any combination thereof.

One or more of the disclosed embodiments may be implemented in a system or an apparatus that includes a portable music player, a personal digital assistant (PDA), a mobile location data unit, a mobile phone, a cellular phone, a computer, a tablet, a portable digital video player, or a portable computer. Additionally, the system or the apparatus may include a communications device, a fixed location data unit, a set top box, an entertainment unit, a navigation device, a monitor, a computer monitor, a television, a tuner, a radio, a satellite radio, a music player, a digital music player, a video player, a digital video player, a digital video disc (DVD) player, a desktop computer, any other device that stores or retrieves data or computer instructions, or a combination thereof. As another illustrative, non-limiting example, the system or the apparatus may include remote units, such as global positioning system (GPS) enabled devices, navigation devices, fixed location data units such as meter reading equipment, or any other electronic device. Although one or more of FIGS. 1-7 illustrate systems, apparatuses, and/or methods according to the teachings of the disclosure, the disclosure is not limited to these illustrated systems, apparatuses, and/or methods. Embodiments of the disclosure may be suitably employed in any device that includes circuitry.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed or that the first element must precede the second element in some manner. Also, unless stated otherwise a set of elements may comprise one or more elements.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

Various illustrative components, blocks, configurations, modules, circuits, and steps have been described above generally in terms of their functionality. Whether such functionality is implemented as hardware or processor executable instructions depends upon the particular application and design constraints imposed on the overall system. Additionally, the various operations of methods described above (e.g., any operation illustrated in the FIGS. 1-7) may be performed by any suitable means capable of performing the operations, such as various hardware and/or software component(s), circuits, and/or module(s). Skilled artisans may implement the described functionality in varying ways for each particular application, but such implementation decisions should not be interpreted as causing a departure from the scope of the present disclosure.

Those of skill in the art would further appreciate that the various illustrative logical blocks, configurations, modules, circuits, and algorithm steps described in connection with the present disclosure may be implemented or performed with a general purpose processor, a digital signal processor (DSP), an application specific integrated circuit (ASIC), a field programmable gate array (FPGA), a programmable logic device (PLD), discrete gate or transistor logic, discrete hardware components (e.g., electronic hardware), computer software executed by a processor, or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored as one or more instructions or code on a computer-readable medium. Computer-readable media includes computer readable storage media and communication media including any medium that facilitates transfer of computer program data from one place to another. A storage media may be any available media that can be accessed by a computer. By way of example, and not limitation, such computer readable storage media can include random access memory (RAM), read-only memory (ROM), programmable read-only memory (PROM), erasable PROM (EPROM), electrically erasable PROM (EEPROM), register(s), hard disk, a removable disk, a compact disc read-only memory (CD-ROM), other optical disk storage, magnetic disk storage, magnetic storage devices, or any other medium that can be used to store program code in the form of instructions or data and that can be accessed by a computer. In the alternative, the computer-readable media (e.g., a storage medium) may be integral to the processor. The processor and the storage medium may reside in an application-specific integrated circuit (ASIC). The ASIC may reside in a computing device or a user terminal In the alternative, the processor and the storage medium may reside as discrete components in a computing device or user terminal.

Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), and floppy disk where disks usually reproduce data magnetically, while discs reproduce data optically with lasers. Thus, in some aspects computer readable medium may include a non-transitory computer readable medium (e.g., tangible media). Combinations of the above should also be included within the scope of computer-readable media.

The methods disclosed herein include one or more steps or actions. The method steps and/or actions may be interchanged with one another without departing from the scope of the claims. In other words, unless a specific order of steps or actions is specified, the order and/or use of specific steps and/or actions may be modified without departing from the scope of the disclosure.

Certain aspects may include a computer program product for performing the operations presented herein. For example, a computer program product may include a computer-readable storage medium having instructions stored (and/or encoded) thereon, the instructions being executable by one or more processors to perform the operations described herein. The computer program product may include packaging material.

Further, it should be appreciated that modules and/or other appropriate means for performing the methods and techniques described herein can be downloaded and/or otherwise obtained by a user terminal and/or base station as applicable. Alternatively, various methods described herein can be provided via storage means (e.g., RAM, ROM, or a physical storage medium such as a compact disc (CD)). Moreover, any other suitable technique for providing the methods and techniques described herein can be utilized. It is to be understood that the scope of the disclosure is not limited to the precise configuration and components illustrated above.

The previous description of the disclosed embodiments is provided to enable a person skilled in the art to make or use the disclosed embodiments. While the foregoing is directed to aspects of the present disclosure, other aspects of the disclosure may be devised without departing from the basic scope thereof, and the scope is determined by the claims that follow. Various modifications, changes and variations may be made in the arrangement, operation, and details of the embodiments described herein without departing from the scope of the disclosure or the claims. Thus, the present disclosure is not intended to be limited to the embodiments herein but is to be accorded the widest scope possible consistent with the principles and novel features as defined by the following claims and equivalents thereof.

What is claimed is:

1. A method comprising:
modulating, at a first wireless device, a first signal based on a Gaussian minimum shift keying (GMSK) modulation scheme to generate a modulated signal;
amplifying, at the first wireless device, the modulated signal using a nonlinear power amplifier to generate an output signal; and
transmitting, from the first wireless device to a second wireless device, the output signal via a wireless local area network (WLAN) that is compliant with an Institute of Electrical and Electronics Engineer (IEEE) 802.11ah specification.

2. The method of claim 1, wherein the output signal is transmitted using a single carrier of the WLAN.

3. The method of claim 1, further comprising:
encoding, at the first wireless device, an input signal using a binary convolutional codes (BCC) encoder to generate the first signal, wherein the input signal corresponds to one or more packets, wherein the BCC encoder is configured to encode signals that are to be modulated using the GMSK modulation scheme and to encode signals that are to be modulated using an orthogonal frequency-division multiplexing (OFDM) modulation scheme.

4. The method of claim 1, wherein the GMSK modulation scheme has a modulation index of 0.5.

5. The method of claim 1, wherein the GMSK modulation scheme is identified as a mandatory modulation scheme of the WLAN by the IEEE 802.11ah specification.

6. The method of claim 1, further comprising:
encoding a second input signal using a binary convolutional codes (BCC) encoder to generate a second input signal;
modulating a second signal based on a orthogonal frequency-division multiplexing (OFDM) modulation scheme to generate a second modulated signal;
amplifying the second modulated signal using a linear power amplifier to generate a second output signal; and
transmitting, from the first wireless device to a third wireless device, the second output signal via the WLAN.

7. A method comprising:
receiving, at a wireless device, a signal via a wireless local area network (WLAN) that is compliant with an Institute of Electrical and Electronics Engineer (IEEE) 802.11ah specification;
when the received signal is modulated based on a Gaussian minimum shift keying (GMSK) modulation scheme:
demodulating, at the wireless device, the received signal using a GMSK demodulator to generate a first signal; and
decoding, at the wireless device, the first signal using a binary convolutional codes (BCC) decoder to generate an output signal, wherein the output signal corresponds to one or more packets;
when the received signal is modulated based on a orthogonal frequency-division multiplexing (OFDM) modulation scheme:
demodulating, at the wireless device, the received signal using an OFDM demodulator to generate the first signal; and
decoding, at the wireless device, the first signal using the BCC decoder to generate the output signal.

8. The method of claim 7, wherein the received signal is transmitted using a single carrier of the WLAN.

9. An apparatus comprising:
a modulator configured to modulate a first signal based on a Gaussian minimum shift keying (GMSK) modulation scheme to generate a modulated signal;
a nonlinear power amplifier configured to amplify the modulated signal to generate an output signal; and
a transmitter configured to transmit the output signal generated based on the amplified signal via a wireless local area network (WLAN) that is compliant with an Institute of Electrical and Electronics Engineer (IEEE) 802.11ah specification.

10. The apparatus of claim 9 further comprising:
a binary convolutional codes (BCC) encoder configured to encode an input signal to generate the first signal, wherein the input signal corresponds to one or more packets.

11. The apparatus of claim 10, wherein the BCC encoder is configured to encode a second input signal to generate a second signal, the apparatus further comprising:
a second modulator configured to modulate the second signal based on an orthogonal frequency-division multiplexing (OFDM) modulation scheme to generate a second modulated signal; and
a linear power amplifier configured to amplify the second modulated signal to generate a second output signal.

12. The apparatus of claim 9, wherein the GMSK modulation scheme is identified as a mandatory modulation scheme of the WLAN by the IEEE 802.11ah specification.

13. An apparatus comprising:
a receiver configured to receive a signal via a wireless local area network (WLAN) that is compliant with an Institute of Electrical and Electronics Engineer (IEEE) 802.11ah specification; and
a Gaussian minimum shift keying (GMSK) demodulator configured to demodulate the received signal based on a GMSK demodulation scheme to generate a first signal when the received signal is modulated based on a GMSK modulation scheme;
an orthogonal frequency-division multiplexing (OFDM) demodulator configured to demodulate the received signal based on a OFDM demodulation scheme to generate the first signal when the received signal is modulated based on an OFDM modulation scheme; and
a binary convolutional codes (BCC) decoder configured to decode the first signal to generate an output signal, wherein the output signal corresponds to one or more packets.

14. The apparatus of claim 13, wherein the received signal is transmitted using a single carrier of the WLAN.

15. An apparatus comprising:
means for modulating a first signal based on a Gaussian minimum shift keying (GMSK) modulation scheme to generate a modulated signal;
means for amplifying the modulated signal nonlinearly to generate an output signal; and
means for transmitting the output signal generated via a wireless local area network (WLAN) that is compliant with an Institute of Electrical and Electronics Engineer (IEEE) 802.11ah specification.

16. The apparatus of claim 15 further comprising:
means for encoding, wherein the means for encoding is configured to:
encode an input signal based on a binary convolutional codes (BCC) encoding scheme to generate the first signal, wherein the input signal corresponds to one or more packets; and
encode a second input signal to generate a second signal;
second means for modulating a second signal based on an orthogonal frequency-division multiplexing (OFDM) modulation scheme to generate a second modulated signal; and
second means for amplifying the second modulated signal linearly to generate a second output signal, wherein the second output signal is transmitted via the WLAN.

17. An apparatus comprising:
means for receiving a signal via a wireless local area network (WLAN) that is compliant with an Institute of Electrical and Electronics Engineer (IEEE) 802.11ah specification;
first means for demodulating the received signal, wherein the first means for demodulating is configured to demodulate the received signal based on a Gaussian minimum shift keying (GMSK) demodulation scheme to generate a first signal when the received signal is modulated based on a GMSK modulation scheme:
second means for demodulating the received signal, wherein the second means for demodulating is configured to demodulate the received signal based on an Orthogonal frequency-division multiplexing (OFDM) demodulation scheme to generate the first signal when the received signal is modulated based on an OFDM modulation scheme; and
means for decoding the first signal based on a binary convolutional codes (BCC) decoding scheme to generate an output signal.

18. A non-transitory computer readable medium comprising processor-executable instructions that, when executed by a processor, cause the processor to perform operations comprising:
modulating, at a first wireless device, a first signal based on a Gaussian minimum shift keying (GMSK) modulation scheme to generate a modulated signal;
amplifying, at the first wireless device, the modulated signal using a nonlinear power amplifier to generate an output signal; and
transmitting, from the first wireless device to a second wireless device, an output signal generated based on the modulated signal via a wireless local area network (WLAN) that is compliant with an Institute of Electrical and Electronics Engineer (IEEE) 802.11ah specification.

19. The non-transitory computer readable medium of claim 18, wherein the operations further comprise:
encoding, at the first wireless device, an input signal using a binary convolutional codes (BCC) encoder to generate the first signal, wherein the input signal corresponds to one or more packets, wherein the BCC encoder is configured to encode signals that are to be modulated using the GMSK modulation scheme and signals that are to be modulated using an orthogonal frequency-division multiplexing (OFDM) modulation scheme.

20. A non-transitory computer readable medium comprising processor-executable instructions that, when executed by a processor, cause the processor to perform operations comprising:
receiving, at a wireless device, a signal via a wireless local area network (WLAN) that is compliant with an Institute of Electrical and Electronics Engineer (IEEE) 802.11ah specification;
when the received signal is modulated based on a Gaussian minimum shift keying (GMSK) modulation scheme:
demodulating, at the wireless device, the received signal using a GMSK demodulator to generate a first signal; and
decoding, at the wireless device, the first signal using a binary convolutional codes (BCC) decoder to generate an output signal, wherein the output signal corresponds to one or more packets;
when the received signal is modulated based on a Orthogonal frequency-division multiplexing (OFDM) modulation scheme:
demodulating, at the wireless device, the received signal using an OFDM demodulator to generate the first signal; and
decoding, at the wireless device, the first signal using the BCC decoder to generate the output signal.

21. A method comprising:
generating, at a wireless device, a Gaussian minimum shift keying (GMSK) modulated packet to be transmitted through a wireless local area network (WLAN) that is compliant with an Institute of Electrical and Electronics Engineer (IEEE) 802.11ah specification, wherein the packet includes:
a preamble, wherein the preamble includes a synchronization (SYNC) field and a start frame delimiter (SFD) field;
a header portion, wherein the header portion includes a length field and a cyclic redundancy check (CRC) field; and
a payload portion.
